(19) United States
(12) Patent Application Publication
(10) Pub. No.: US 2004/0124984 A1
(43) Pub. Date: Jul. 1, 2004

(54) Fishing rod holder with fish strike sensor and alarm

(76) Inventor: Larry Fuller, Pierre, SD (US)

Correspondence Address: Paul J. Robbennolt, DORSEY & WHITNEY LLP, Intellectual Property Department, 50 South Sixth Street, Suite 1500, Minneapolis, MN, 55402-1498, US

(21) Appl. No.: 10/736,050

(22) Filed: Dec. 15, 2003

Related U.S. Application Data
(60) Provisional application No. 60/433,498, filed on Dec. 13, 2002.

(51) Int. Cl. G08B 23/00

(52) U.S. Cl. 340/573.2

(57) ABSTRACT

An apparatus for supporting and holding a fishing rod that includes a sensing device to detect a fish strike and an alarm to signal the fish strike audibly and/or visually to the user. Then invention includes a structure that holds and supports the fishing rod in an upright position. The handle of the fishing rod is placed in a tubular fishing rod holder. A fish strike pulls the tip of the fishing rod down, thereby forcing the proximal end of the handle of the fishing rod up within the fishing rod holder. The fishing rod handle activates a switch which closes an electric circuit. An alarm is in turn connected to the tubular fishing rod holder. When a fish strikes, and the switch is activated, a circuit is closed, activating the alarm and producing an audio and/or visual signal. The device permits the user to select among two or more distinct audio alarms, thereby allowing multiple users to operate the invention in the same location at the same time. The device also permits the user to select among two or more distinct lights, thereby allowing multiple users to operate the invention in the same location at the same time.

### CROSS-REFERENCE TO RELATED APPLICATION

The present application claims priority to U.S. provisional patent application 60/433,498, filed Dec. 13, 2002, which is incorporated herein by reference in its entirety.

### BACKGROUND OF THE INVENTION

In the normal operation of a fishing rod, a fisherman must hold the rod to detect a fish strike. When the fish strikes, the line is drawn taut and pulls the end of the fishing rod down. The fisherman, who is holding the fishing rod, feels the pull on the rod, and therefore knows to recover the fish. This creates certain limitations for the fisherman. In particular, the fisherman cannot feel fish strikes if he is not holding the fishing rod.

Fishing rod holders are available commercially that support and hold fishing rods in an upright position so that the fisherman is not required to hold the rod at all times. When the fisherman has a line in the water and the fishing rod in the fishing rod holder, he can detect a fish strike by watching the tip of the fishing rod to see if it is pulled down by the tension on the line caused by a strike. Although the fisherman no longer is required to hold the fishing rod in order to detect a strike, he cannot detect a fish strike unless he is watching the fishing rod closely.

Therefore, a need exists for a device that will support and hold a fishing rod in an upright position and signal to the fisherman when a fish strikes.

### SUMMARY OF THE INVENTION

The present invention relates to fishing equipment. More specifically, the present invention relates to an apparatus for supporting and holding a fishing rod that includes a sensing device to detect a fish strike and an alarm to signal the fish strike audibly or visually to the user.

The present invention allows a user to fish without holding the fishing rod at all times. The invention holds and supports the fishing rod in a generally upright position. Furthermore, the user need not watch the fishing rod in order to detect a fish strike. The present invention signals the user, through the use of an audio or visual signal, of a fish strike, thereby gaining the attention of the user. Finally, through the use of two or more visual and/or audio signals, the invention may be sued by two or more users in the same location. Each user may select a distinct audio or visual signal.

In use, the handle of the fishing rod is placed in a support such as a tubular fishing rod holder. The support may be connected to a spike which is placed in the ground, thereby holding the support and the fishing rod in an upright position. It is understood that other means may be used to secure the fishing rod support. For example, a clamp may be used to connect the support to a boat gunwale.

The invention includes a device that detects tension on the fishing line caused by a fish strike. The tension on the fishing line pulls the tip of the fishing rod down. The fishing rod then acts as a lever, with the tubular fishing rod holder or other support acting as the fulcrum. When the fish strike pulls the tip of the fishing rod down, this in turn forces the distal end of the handle of the fishing rod (the end connected to the remaining portion of the fishing rod) down. Because the tubular fishing rod holder acts as a fulcrum, the proximal end of the fishing rod handle is thus forced up. The proximal end of the fishing rod handle activates a switch which closes an electric circuit. The fishing rod handle may activate the switch by pushing on a flexible member, such as a spring clip, which in turn pushes a switch in the form of a button. An alarm is in turn connected to the fishing rod holder. When a fish strikes, and the switch is activated, a circuit is closed, activating the alarm and producing an audio and/or visual signal. The device permits the user to select among two or more distinct audio alarms, thereby allowing multiple users to operate the invention in the same location at the same time. The device also permits the user to select among two or more distinct lights, thereby allowing multiple users to operate the invention in the same location at the same time.

It is an object of the present invention to provide an apparatus that allows a fisherman to detect fish strikes without holding the fishing rod. It is a similar object of the present invention to provide an apparatus that allows a fisherman to detect fish strikes without watching the fishing rod. It is another object of the invention to provide an apparatus that allows hearing impaired or sight impaired users to detect fish strikes without holding the fishing rod. It is still another object of the present invention to provide an apparatus that permits users to detect fish strikes while ice fishing. It is yet another object of the present invention to provide an apparatus that allows users to detect fish strikes while fishing at night. It is a similar object of the present invention to provide an apparatus that allows users to detect fish strikes while fishing at night without losing their night vision, through the use of a red light or red lens for the visual signal. It is a further object of the invention to allow two or more users to use the device in the same location through the use of two or more visual and/or audio signals. It is yet another object of the invention to provide an apparatus that adds enjoyment to the activity of fishing for children. Other objects and advantages of the present invention will become more fully apparent and understood with reference to the following specification and to the appended drawings.

### BRIEF DESCRIPTION OF THE DRAWINGS

FIG. 1 is a perspective view of a fishing rod holder with fish strike sensor and alarm in accordance with the present invention.

FIG. 2 is a perspective view of the fishing rod holder of FIG. 1 with a fishing rod showing a fish strike.

FIG. 3 is a perspective view of the fishing rod holder to show how the fishing rod contacts the flexible member of the fish strike sensor and alarm of the present invention.

FIG. 4 is the perspective view of FIG. 3 showing the operation of the present invention when a fish strikes.

### DESCRIPTION OF THE INVENTION

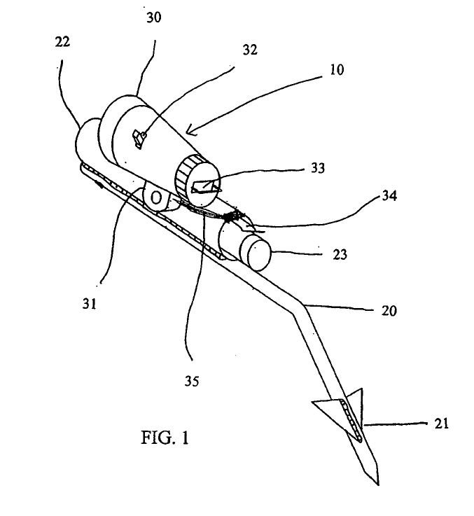

One embodiment of the fishing rod holder with fish strike sensor and alarm 10 is shown in FIG. 1. In the preferred embodiment, the fishing rod holder 22 is a tubular structure that is open on both ends and of sufficient diameter to accommodate a variety of handles of fishing rods 23. The fishing rod holder 22 is attached to a bar 20 that supports it. The bar 20 includes a spike 21 or other structure that is placed in the ground and secures and supports the fishing rod 23 in the upright position.

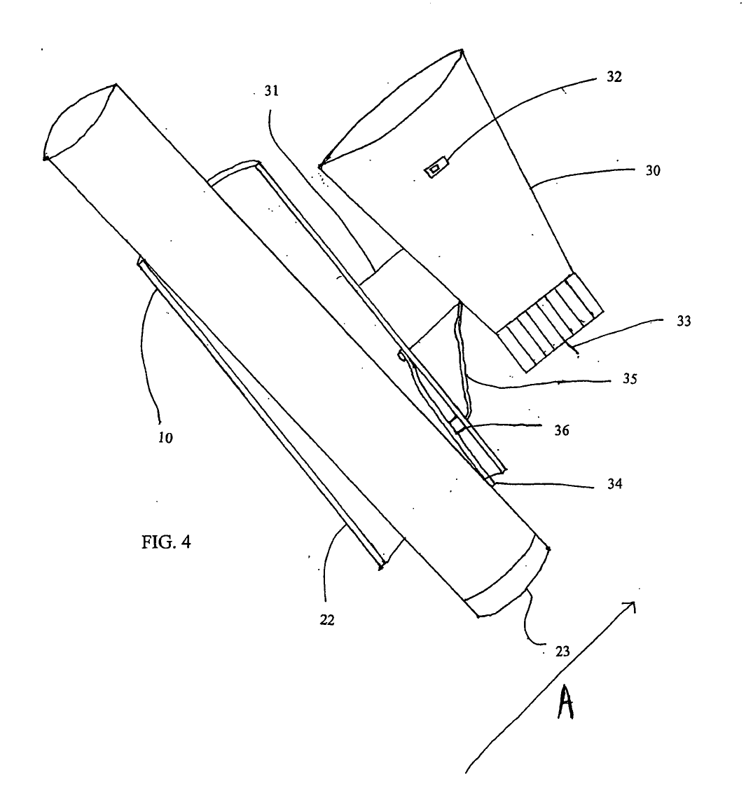

An alarm 30 also is attached to the fishing rod holder 22. The alarm 30 may be attached to the fishing rod holder 22 using a connector 31. The alarm 30 is wired to a switch that is housed in the fishing rod holder 22 using wires 35. A flexible member 34 is connected to the interior of the fishing rod holder 22 over the switch. When a fish strikes the line, the tip of the fishing rod is pulled down, which in turn forces up the proximal end of the handle of the fishing rod 23. As seen in FIG. 4, the handle of the fishing rod 23 depresses the flexible member 34, which in turn depresses the switch 36, closing the circuit of the alarm 30. The alarm 30 is thus activated and produces an audio and/or visual signal.

The alarm 30 is capable of producing one or more audio signals when it is activated, thereby allowing multiple users to operate the invention in the same location. The user may select from among the two or more audio signals through the use of a selector 32. The alarm 30 also is capable of producing one or more visual signals when it is activated, such as different colored lights 33. Again, the user may select from among the two or more visual signals through the use of a selector 32.

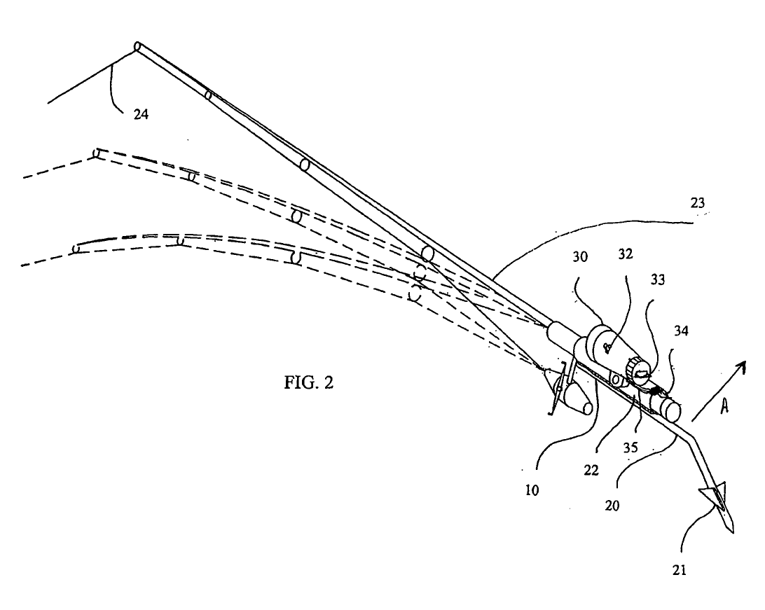

FIG. 2 shows the preferred embodiment of the invention 10 of FIG. 1 when a fish strikes. Before the fish strikes, the fishing rod 23 is in the most upright position. When the fish strikes, it creates tension on fishing line 24, which pulls down the tip of the fishing rod 23 as shown. The distal end of the handle of fishing rod 23, which is held in fishing rod holder 22, is forced down as well. The fishing rod holder 22 acts as a fulcrum, and the proximal end of the handle of fishing rod 23 is thus forced upward in the direction of Arrow A, depressing flexible member 34. The spring clip 34 in turn depresses a switch housed inside fishing rod holder 22, which closes the circuit for alarm 30 and thereby activates the alarm.

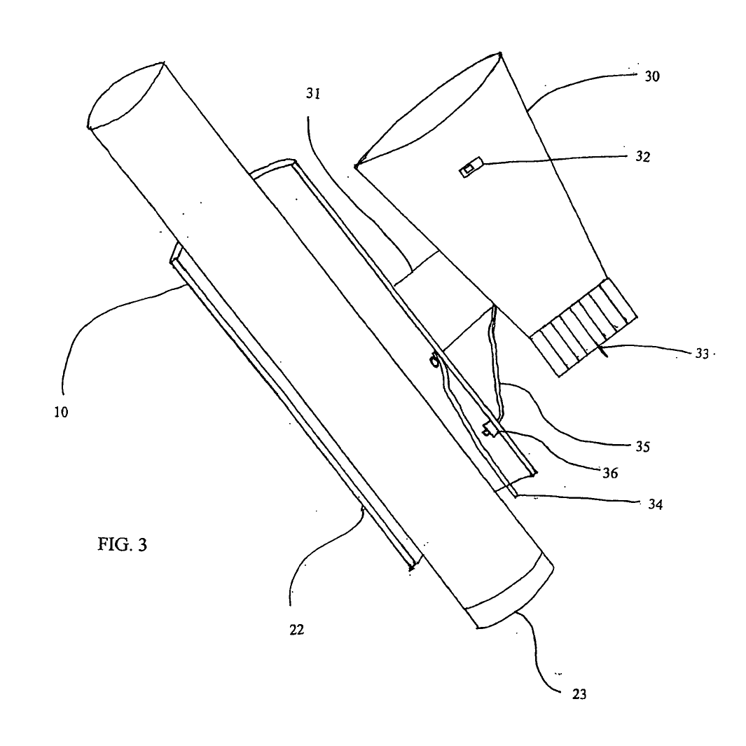

FIG. 3 shows a cross-sectional view of the fishing rod holder of the preferred embodiment of the present invention 10. As shown, the handle of the fishing rod 23 is held and supported in the upright position within fishing rod holder 22. The switch 36 is mounted inside the fishing rod holder 22. Also mounted inside the fishing rod holder 22, between the handle of fishing rod 23 and the switch 36, is the flexible member 34. The switch is connected electrically to the alarm 30 with wires 35.

FIG. 4 shows the cross-sectional view of the fishing rod holder 22 of the preferred embodiment of the present invention 10 of FIG. 3 when a fish strikes. When the fish strikes, the tip of fishing rod 23 and the distal end of the handle of fishing rod 23 are pulled down. The fishing rod holder 22 acts as a fulcrum, forcing the proximal end of the handle of fishing rod 23 up in the direction of Arrow A, thereby depressing the flexible member 34 against the switch 36. The switch 36 thus closes the circuit of alarm 30, activating the alarm and producing an audio and or visual signal. The alarm 30 is capable of producing one or more audio signals when it is activated, thereby allowing multiple users to operate the invention in the same location. The user may select from among the two or more audio signals through the use of a selector 32. The alarm 30 also is capable of producing one or more visual signals when it is activated, such as different colored lights 33. Again, the user may select from among the two or more visual signals through the use of a selector 32.

Although a description of the preferred embodiments have been presented, it is contemplated that various changes, including those mentioned above, could be made without deviating from the spirit of the present invention. For example, the shape or design of the fishing rod holder could be changed to accommodate various fishing rods. The means for securing the fishing rod holder to the ground or another surface could be changed. The alarm could be modified to alert the user to a fish strike using a digital recording of a voice, including a voice signal recorded by the user. The alarm could also be modified to alert the user to a fish strike using music. The fish strike sensor and alarm could be available separately with a kit to permit the user to attach it to a commercially available fishing rod holder. The visual signal of the fish strike sensor and alarm could be accomplished using white or colored light bulbs, light emitting diodes, or other light source. The fish strike sensor and alarm could be modified to accommodate lenses for the lights of the visual signals to change their color.

What is claimed is:

1. A fishing rod holder with fish strike sensor and alarm comprising:
a hollow structure open on at least one end for holding the handle of a fishing rod;
means for securing the hollow structure to the ground or other surface;
a switch mounted on the hollow structure;
an alarm mounted on the hollow structure capable of producing an audio signal when its circuit is closed, said switch being electrically connected to said alarm and capable of being open or closed; and
a flexible member mounted on the hollow structure capable of being depressed and, when depressed, capable of pressing said switch and closing the circuit of said alarm.

2. The fishing rod holder with fish strike sensor and alarm of claim 1, in which said alarm is capable of producing two or more audio signals when its circuit is closed.

3. The fishing rod holder with fish strike sensor and alarm of claim 2, further comprising:
a means for selecting among the two or more audio signals.

4. A fishing rod holder with fish strike sensor and alarm comprising:
a hollow structure open on at least one end for holding the handle of a fishing rod;
means for securing the hollow structure to the ground or other surface;
a switch mounted on the hollow structure;
an alarm mounted on the hollow structure capable of producing an visual signal when its circuit is closed, said switch being electrically connected to said alarm and capable of being open or closed; and
a flexible member mounted on the hollow structure capable of being depressed and, when depressed, capable of pressing said switch and closing the circuit of said alarm.

5. The fishing rod holder with fish strike sensor and alarm of claim 4, in which said alarm is capable of producing two or more visual signals when its circuit is closed.

6. The fishing rod holder with fish strike sensor and alarm of claim 5, further comprising:
a means for selecting among the two or more visual signals.

7. A fishing rod holder comprising:
a hollow structure open on at least one end for holding the handle of a fishing rod;
means for securing the hollow structure to the ground or other surface;
a switch mounted within the hollow structure;
an alarm mounted on the hollow structure capable of producing an audio signal or a visual signal when its circuit is closed, said switch being electrically connected to said alarm and capable of being open or closed; and
a flexible member mounted within the hollow structure capable of being depressed and, when depressed, capable of pressing said switch and closing the circuit of said alarm.

8. The fishing rod holder of claim 7, in which said alarm is capable of producing two or more audio signals when its circuit is closed.

9. The fishing rod holder of claim 8, further comprising:
a means for selecting among the two or more audio signals.

10. The fishing rod holder of claim 9, in which the means for selecting among the two or more audio signals is a switch.

11. The fishing rod holder of claim 9, in which the means for selecting among the two or more audio signals is a button.

12. The fishing rod holder of claim 7, in which said alarm is capable of producing two or more visual signals when its circuit is closed.

13. The fishing rod holder of claim 12, further comprising:
a means for selecting among the two or more visual signals.

14. The fishing rod holder of claim 13, in which the means for selecting among the two or more visual signals is a switch.

15. The fishing rod holder of claim 13, in which the means for selecting among the two or more visual signals is a button.

16. The fishing rod holder of claim 7, in which the means for securing the hollow structure to the ground or other surface is a clamp.

17. The fishing rod holder of claim 7, in which the means for securing the hollow structure to the ground or other surface is a pointed rod.

18. The fishing rod holder of claim 7, in which the means for securing the hollow structure to the ground or other surface is a weighted base.

19. A fish strike sensor and alarm comprising:
a switch capable of being mounted on a fishing rod holder; and
an alarm capable of being mounted on a fishing rod holder, said alarm capable of producing an audio signal when its circuit is closed, and said switch being electrically connected to said alarm and capable of being open or closed.
